(19) United States
(12) Patent Application Publication
(10) Pub. No.: US 2004/0206816 A1
(43) Pub. Date: Oct. 21, 2004

(54) Automated parking payment system using ATM network

(76) Inventors: Kaushal Gokli, West Chester, OH (US); Jim D. Hamann, Florence, KY (US); Wade Calkins, Cincinnati, OH (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/420,394

(22) Filed: Apr. 21, 2003

(51) Int. Cl. G06K 5/00

(52) U.S. Cl. 235/382; 235/380

(57) ABSTRACT

An automated parking fee payment station using an ATM network is provided. The payment station includes ATM apparatus including the keypad, a card reader, a display, a communications interface and a micro-computer controller. The payment station further includes parking fee calculating and collection apparatus having a ticket reader and parking fee collection apparatus. The ticket reader and parking fee collection apparatus are operatively connected to and utilize the resources of the micro-computer controller, to allow payment of the parking fee by transaction of the ATM.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates to parking payment stations for automatically calculating and collecting parking fees, either adjacent to or remote from parking lots. More particularly, the present invention relates to a parking payment station that includes a cash dispensing mechanism, such as an Automated Teller Machine (ATM), for dispensing cash to users.

Conventional parking payment stations calculate the parking fee by reading the vehicle entry time recorded on the ticket, comparing that time to current time, and calculating the parking fee. Upon payment of the parking fee an exit gate may be opened allowing a vehicle to leave the parking lot. The fee may be collected by a human operator or by the insertion of cash or credit card into the parking payment station. One such parking payment station is the AGP-7000 Automatic Pay Station marketed by AMANO CINCINNATI, INC., the assignee of the present invention. Such devices also include a coin handling mechanism to receive cash payments and dispense change, based on the insertion of payments in excess of the calculated parking fee.

Such contemporary automatic pay stations may be disposed at locations remote from the parking lot, such as in hotel lobbies, airport terminals, or at entryways of various public attractions. Where the pay stations are located remote from the parking lot, the pay station may operate to dispense a payment ticket which allows the user to exit the parking lot freely, provided that the user exits the parking lot within a preset time after the payment is made at the remote pay station. Such devices are disclosed in U.S. Pat. No. 4,571,490 for Parking Station Supervisory System issued to AMANO CINCINNATI, INC.

While such contemporary devices provide convenient operation for users, from a variety of locations, they do not dispense cash beyond that necessary to give change for the appropriate parking payment fee. As such, should a user desire to obtain cash he or she would typically be required to locate a separate ATM machine, possibly in a different area, before cash could be obtained. Moreover, conventional automatic pay stations do not accept ATM (debit) cards for payment of parking fees. Consequently, a user may first have to locate an ATM machine to obtain cash and then return to a parking pay station to pay the parking fee. This is obviously inefficient, inconvenient and unnecessary insofar as the parking pay station may already incorporate a communication link, e.g. for accepting credit card payments, and a cash dispensing mechanism, e.g. for dispensing change. It would clearly be desirable for an automatic parking pay station to include functionality to both accept ATM cards as a means of payment, and to dispense cash to a user, beyond simply change, either as an ATM withdrawal, or as a cash payment against a credit card.

The present invention is directed to an improved parking pay station which incorporates additional functionality that allows the pay station to operate as an ATM machine, or to dispense cash based on a credit card charge. Such a system provides greater convenience to a user, avoiding the necessity for locating two or three separate mechanisms, if available, within a service area.

### SUMMARY OF THE INVENTION

An automated parking fee payment station using an ATM network is provided. The payment station includes ATM apparatus including the keypad, a card reader, a display, a communications interface and a micro-computer controller. The payment station further includes parking fee calculating and collection apparatus having a ticket reader and parking fee collection apparatus. The ticket reader and parking fee collection apparatus are operatively connected to and utilize the resources of the ATM micro-computer controller, to allow payment of the parking fee by transaction of the ATM.

The ATM apparatus or the parking fee collecting and calculating apparatus may include a cash dispenser allowing the user to obtain cash from the station, independent of payment of a parking fee.

The automated parking fee payment station may receive payment by cash input and/or by charge to an ATM/debit/credit card, transacted through an ATM network. The ATM network may be operative to transact a cash withdrawal and/or payment of the parking fee through a consumer banking institution i.e. an automated clearing house, a bank, credit card network or other financial institution. Cash may be dispensed as change from payment of a parking fee, or as a cash withdrawal, independent of and/or in combination with any parking fee transaction.

The ATM and parking fee calculating and collection apparatus may incorporate independent micro-computer controllers, or may utilize shared resources of a micro-computer controller, resident in the ATM apparatus and/or in the parking fee calculating and collection apparatus.

### BRIEF DESCRIPTION OF THE DRAWINGS

FIG. 1 is a block diagram of a conventional ATM system, which may be utilized in conjunction with the present invention, illustrating the transactions that occur during a typical ATM transaction;

FIG. 2 is a block diagram illustrating a conventional parking fee pay station that may be utilized in conjunction with the present invention;

FIG. 3 is a block diagram illustrating one embodiment of the present invention; and

FIG. 4 is a block diagram illustrating one embodiment of the parking fee calculating and collection apparatus utilized in the present invention.

### DETAILED DESCRIPTION OF THE INVENTION

The presently preferred embodiment of the invention is described below with respect to the accompanied illustrations. However, as will be recognized by those skilled in the art, various other embodiments of the invention may be implemented without departing from the broader spirit and scope of the invention. As such, different types of ATM mechanisms, credit card processing mechanisms and parking payment mechanisms may be implemented within the broader aspects of the present invention. Other enhancements may facilitate additional functionality beyond that addressed in the present application. Accordingly, the invention is not intended to be limited by the particular embodiments that are disclosed herein.

The present invention merges functionality of parking payment stations, in their various implementations, with the functionality of ATMs. The ATM may be implemented in different embodiments, such as point of purchase mechanisms commonly found at grocery stores, or stand alone ATM mechanisms. The basic functionality of such mechanisms, as applicable to the present invention, is set forth below in relation to the presently preferred embodiment of the invention.

Numerous processes and devices exist for facilitating cash distribution payments as contemplated under the present inventor. Today, virtually all domestic banking institutions offer customers the ability to conduct a limited number of electronic transactions either from an ATM located on-site at the institution or from a remote ATM serving the institution. The remote services are made possible in part through the development of communications systems that provide for the interconnection of many clearing house or regional, national, or international electronic funds transfer (EFT) networks. These networks are specialized digital packet networks that communicate with various ATM transaction processors and service providers using standard message protocols developed by ANSI and others. A more-or-less standard, generic ATM interface has developed in the banking industry, making it relatively easy for a consumer to use any ATM on any ATM network once he has learned how to interact with this more-or-less standard interface. Of course, ATMs produced by different manufacturers may differ in key placement, number of keys, key legends, screen size, etc. However, there has been a trend toward standardization of these features so as to minimize user discomfort with using a “foreign bank” ATM.

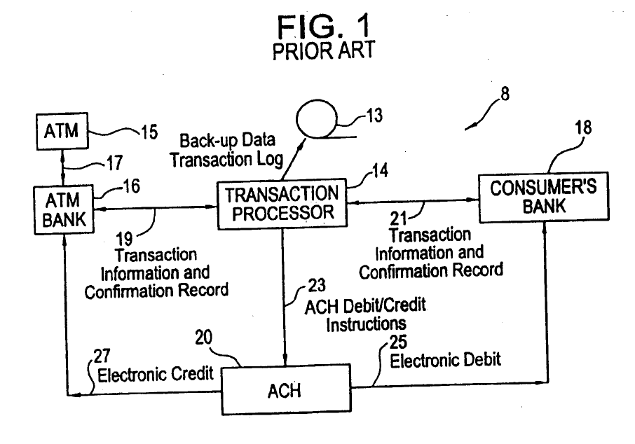

FIG. 1 illustrates a block diagram of a conventional ATM mechanism that may be used in conjunction with a parking payment station in accordance with the present invention. Inclusion of such a mechanism allows the parking payment station to process a typical ATM transaction, such as a cash withdrawal or balance inquiry, shown generally at 8. As seen in FIG. 1, the ATM transaction system includes an ATM micro-computer controller, or transaction processor 14, an ATM network access device (such as an ATM terminal) 15, an ATM banking institution 16, a consumer banking institution 18 (where the ATM banking institution 16 and the consumer banking institution 18 can be one and the same), and an automated clearing house (ACH) network 20. ATM network access device 15 is connected to ATM banking institution 16 through a suitable communications path 17. ATM transaction processor 14 is connected with a host computer at ATM banking institution 16 through communications path 19, with a host computer at consumer banking institution 18 through communications path 21 and with ACH network 20 through communications path 23. As is known to those of skill in the art, appropriate information is exchanged between ATM transaction processor 14, ATM banking institution 16, consumer banking institution 18, and ACH network 20 to effect an ATM transaction.

In operation, ATM network access device 15 serves as an interface between a user and the ATM network to receive input from the user and to provide necessary output (and funds, when necessary) to the user. ATM network access device 15 retrieves user information from an ATM card inserted by a user to initiate an ATM transaction, and receives appropriate associated PIN information and transaction information from the user. This information is passed through communication path 17 to the ATM banking institution 16. As necessary, information is then transferred through communications path 19 to ATM transaction processor 14. ATM transaction processor 14 identifies the consumer banking institution 18 from the information retrieved from the user's ATM card, and passes the necessary transaction information entered by the user to the appropriate consumer banking institution 18 through communications path 21.

Consumer banking institution 18 verifies the user's account data and verifies that the user has sufficient funds available for the requested transaction. Consumer banking institution 18 then forwards an authorization message (either a deny transaction request message or to proceed with transaction message, for example) to the ATM transaction processor 14 through communications path 21. ATM transaction processor 14 then forwards the authorization message back to the ATM banking institution 16 through communications path 19. These messages serve to confirm that the transaction is to proceed or be prohibited. Upon receipt of the authorization message, the ATM banking institution 16 forwards the authorization to the ATM network access device 15 using communications path 17. Based on the authorization received, the ATM network access device 15 provides suitable information and funds, if requested, to the user. The user then has the option of terminating the session, or initiating another transaction, which would proceed in a similar fashion.

Once the consumer has terminated the ATM banking session, the ATM transaction processor 14 forwards a confirmation record of the completed transaction to the ATM banking institution 16 using communications path 19, and forwards an identical confirmation record to the consumer's banking institution 18 using communications path 21. ATM transaction processor 14 also forwards a record of the transaction and information to facilitate the appropriate debiting and crediting of the necessary accounts to a designated ACH network 20 through communications path 23. ACH network 20 then operates to debit (where the user has requested a withdrawal of funds, for example) the user's account at the consumer banking institution 18 using communications path 25, and to issue a credit to the ATM banking institution 16 using communications path 27. Finally, ATM transaction processor 14 creates a record of the transaction and writes that record to a back-up data and transactions log 13 for any future reference, if necessary.

Currently, ATM functions for reading and processing ATM/credit card information have been implemented in compact devices used for a variety of Point-of-sale (POS) transactions. Such devices are growing more prevalent, with small ATM card readers and key pads appearing in grocery stores, convenience stores and gas stations, among others. While the predominant use of the POS terminals has been to speed the check-out time (increase payment efficiency), POS debit transactions have also provided a substitution for cash and have served to reduce the number of checks returned to the vendor due to insufficient consumer funds balances. During a POS transaction, the consumer swipes the ATM (or debit) card through a card reader. Assuming an on-line debit transaction (versus an off-line credit-oriented transaction), the consumer enters a unique personal identification number (PIN), and then waits for the card reader/register to communicate to the transactions processor the total amount of the sale (i.e., the amount to be debited from the consumer's transaction account to pay a parking fee). In U.S. Pat. No. 5,484,988, Delfer describes a similar process that scans a consumer's account information from a physical paper check presented at the point-of-sale. Such a check reader may be utilized in connection with the ATM to provide additional functionality to the system.

After receiving verification from the consumer's bank that sufficient funds exist in the consumer's account to cover the transaction and an authorization from the consumer's bank to proceed, the transactions processor forwards to the POS terminal a transaction approval message (or, in the case of insufficient funds, a denial). Funds are routed from the consumer's bank account to the parking vendor through an ACH network. In accordance with the present invention such a device may be incorporated into a parking payment station, electronically interfacing with the cash dispensing mechanism and communication link already present in the station.

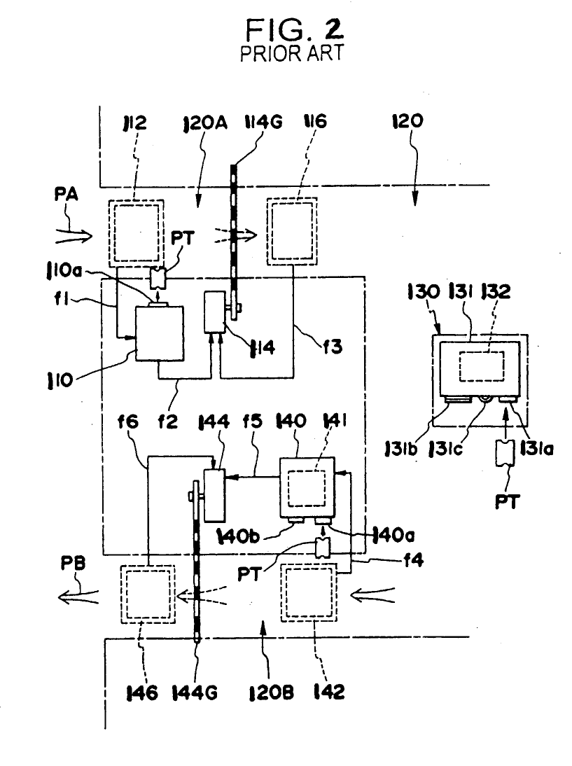

FIG. 2 illustrates a block diagram of conventional parking station supervisory system, which may be combined with the ATM network illustrated at FIG. 1. In the drawing, numeral 110 denotes a parking ticket issuance device installed close to a vehicle entrance 120a of a parking station 120. Numeral 112 denotes a first vehicle detector such as a loop coil embedded in a vehicle passage at the inner area of the entrance 120. When a vehicle (not shown) advancing in the direction shown by an arrow PA is detected by said first vehicle detector 112, a signal or detecting signal f1 is sent into the parking ticket issuance device 110 from said detector 112. In accordance with said signal f1, the parking ticket issuance device 110 issues a parking ticket PT. When a driver pulls out the parking ticket PT from a ticket issuing pocket 110a, a signal or gate opening signal f2 is sent into an entrance gate driving mechanism 114 from said parking ticket issuance device 110. According to said signal f2, an entrance gate bar 114g rotatably connected at its one end to said entrance driving mechanism 114 is opened allowing the vehicle to enter. Numeral 116 denotes a second vehicle detector such as a loop coil embedded in a vehicle passage at the inner area of said entrance gate bar 114g. When the vehicle passes on the second vehicle detector 116, a signal or gate closing signal f3 is sent into said entrance gate driving mechanism 114 for closing said entrance gate bar 114g and thus a vehicle entry is completed.

Next, numeral 130 denotes a parking payment station or settlement station in accordance with the present invention, installed at an appropriate place or places inside or outside of the parking area. Preferably, it should be installed at a convenient place or places for drivers or users, e.g. in a terminal. Numeral 131 denotes a manned or unmanned parking payment station, provided at the inside of said parking fee adjusting station 130. Numeral 132 denotes a computing and processing unit assembled in said parking fee adjusting device 131. When a driver or user inserts a parking ticket issued by said parking ticket issuance device 120a into a parking ticket receiving pocket 131a provided at the front of said parking fee adjusting device 131, said parking fee adjusting device 131 calculates the parking fee based on time difference between the entry time and the present time or departure time and the parking fee is shown on a display 131b. Where an unmanned parking fee adjusting device 131 is employed, when a driver effects the required payment by depositing cash corresponding to the parking fee shown on the display 131b, the parking ticket PT is automatically returned again to said parking ticket receiving pocket 131a after recording an allowable departure time thereon, which is determined by adding a pre-fixed time, for example, about 10 to 30 minutes, to the present time. Where a manned parking fee adjusting device 131 is employed, a clerk-in-charge returns the parking ticket PT to the driver upon receiving the parking fee and recording the allowable departure time.

Numeral 140 denotes a departure control device or controlling machine installed close to an exit 120b of the parking station 120 and numeral 141 denotes a computing and processing unit assembled therein. When said computing and processing unit 141 receives a vehicle detecting signal F4 from a first exit detector 142 such as loop coil embedded in a vehicle passage at the inner area of the vehicle exit 120b, it opens a parking ticket receiving pocket 140a thereby permitting the parking ticket PT to be inserted. At the same time, when said computing and processing unit 141 finds that the present time is within said allowable departure time, it sends a signal or gate opening signal f5 into a gate driving mechanism 144 to open an exit gate bar 144g for allowing a vehicle to leave. When the present time is found to be over the allowable departure time, the gate opening signal f5 is not sent into the exit gate driving mechanism 144 thereby prohibiting the departure of a vehicle. In this case, a clerk-in-charge inserts another card manually to show an extra parking fee on a display 140b. Upon payment of the extra parking fee, the vehicle can leave the exit gate as in the same manner as mentioned above.

As described in the foregoing, when a vehicle is to be left after shopping or the like is finished, the driver or user can drop in the parking fee adjusting station first and effect the settlement of the parking fee. Then, he can drive his vehicle towards the exit within the allowable departure time recorded on the parking ticket returned. At the exit the user inserts the parking ticket into the vehicle departure control device, and then the exit gate bar is opened for allowing the vehicle to leave. Since payment is not required when the parking fee is already settled, the parking fee adjustment or settlement can be quite smoothly conducted. Moreover, since the departure control device reads the parking ticket, finds whether or not it is within the allowable departure time and opens the exit gate bar immediately for allowing the vehicle to leave, if it is found to be within the allowable departure time, there is no worry for drivers to wait for a long time at the parking fee adjusting device or the vehicle exit of the parking station by forming a long waiting line of vehicles. Drivers do not have to pay unreasonable extra parking fees due to long waiting time for settlement of the parking fee.

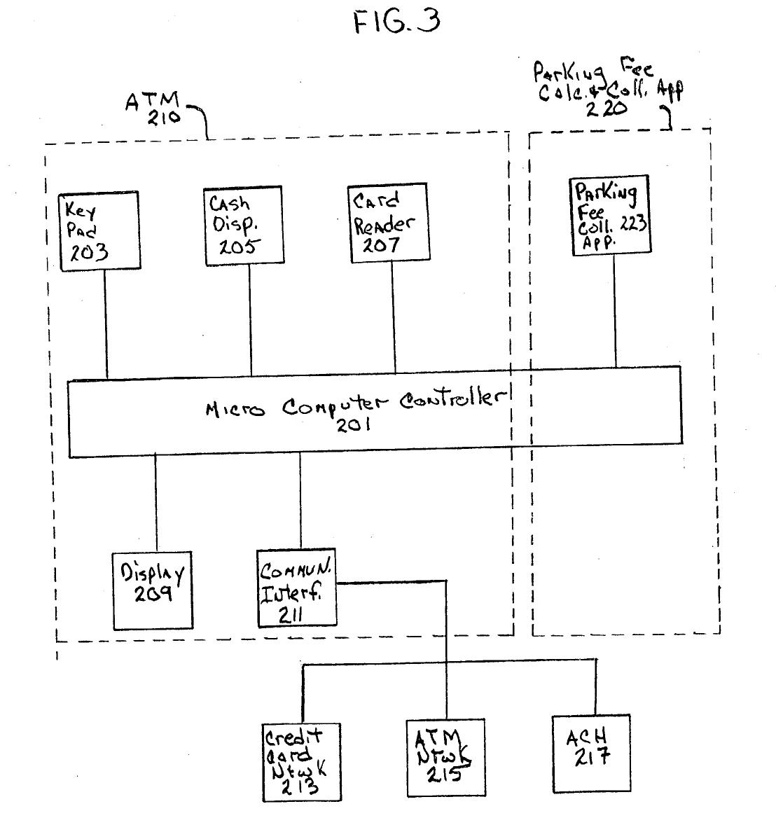

FIG. 3 is a block diagram illustrating one embodiment of the present invention, which merges the aforementioned functionalities of an ATM network and a parking payment station. As shown therein an automated parking payment system is provided, using facilities of an ATM apparatus and network. The system 200 includes ATM apparatus 210 and parking fee calculation and collection apparatus 220. The ATM apparatus 210 may generally be implemented as a conventional ATM mechanism operative to access a users, consumer baking institution, for the distribution of cash to a user. In some embodiments the ATM apparatus 210 may be implemented as a point of sale ATM card reader and keypad, such as typically appears in grocery stores and convenience stores, without associated cash dispensing apparatus. In such cases the parking fee may be calculated and collected via use of the ATM apparatus and ATM network facilities, though no cash dispensing functionality is provided.

The parking fee calculating and collection apparatus may alternately be implemented as a parking payment station, similar to the AMANO AGP-7000 Station. In such a configuration the parking fee calculating and collection apparatus 210 would include ticket reading mechanism, parking fee collecting apparatus and change dispenser, all operatively connected to a micro-computer controller.

In other embodiments the parking fee calculation and collection apparatus 220 may be implemented in a more compact arrangement, utilizing the resources of the ATM apparatus 210 for micro-processor control and for cash dispensation, where the system includes a cash dispenser.

In short, the system 200 is implemented by a merger of an ATM mechanism and a parking pay station mechanism, where the functionality and control mechanisms may be distributed between the ATM mechanism and the parking payment mechanism as most convenient, to avoid duplication of mechanisms and facilitate interaction and common control of the mechanisms.

As shown in FIG. 3, the ATM mechanism 210 includes micro-processor 201 which is an electrical communication with keypad 203, cash dispensing mechanism 205, card reader 207, display 209 and communications interface 211. Parking fee calculation and collection apparatus 220 is shown in electrical communication with the micro-computer 201 and preferably shares the resources of micro-computer 201. As such, the calculated parking fee may be illustrated at display 209, and payment of the calculated fee may be effected by inserting a debit or credit card into card reader 207 and accessing a credit card network or ATM network, through communications interface 211, to pay the calculated parking fee. Keypad 203 may be utilized to input personal identification codes or the like in order to assure user account security for transactions.

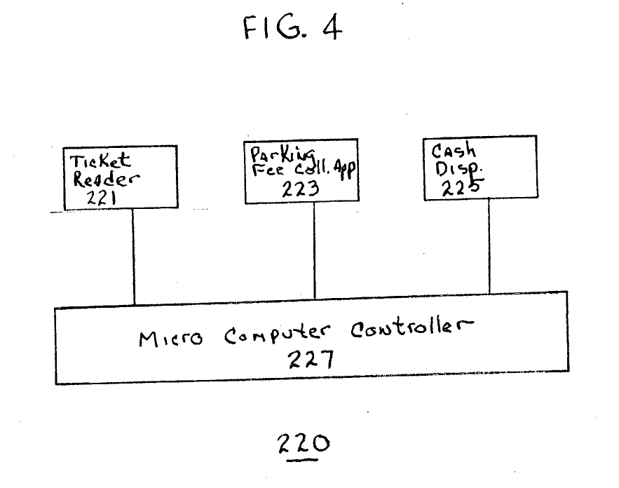

FIG. 4 illustrates one embodiment of the parking fee calculation and collection apparatus 220, shown at FIG. 3. The apparatus 220 includes ticket reader 221, parking fee collection apparatus 223, and change dispenser 225. Each of those devices are an electrical communication with micro-computer 227, which may be implemented as resources of micro-computer 201, or as a separate controller, in communication with micro-controller 201.

As noted above, functions of the parking fee calculating and collection apparatus 220 may be implemented instead by the ATM apparatus 210. As such, change dispenser 225 may be eliminated in preference to use of cash dispenser 205 of ATM apparatus 210. In one embodiment, parking fee payment may be exclusively by means of a credit or debit card, without provision for cash or change dispensing. In such an embodiment, cash dispenser 205 may operate in accordance with a conventional ATM apparatus, but not to dispense change from cash payment of the parking fee.

In another embodiment the change dispensing apparatus 225 may be eliminated from the parking fee calculating and collection apparatus 220, with change dispensing functionality provided to ATM cash dispensing apparatus 205. Also, as discussed above, a check reader may be utilized in conjunction with the system to provide yet another media for payment of a parking fee and/or receipt of cash.

The parking fee collection apparatus 223 may operate to receive cash for settlement of the parking fee, which then allows validation of the parking ticket. In another embodiment the parking fee collection apparatus does not accept cash payment, but instead operates to process collection of the parking fee, based on the ATM transaction, and validate the parking ticket.

As will be apparent to those of ordinary skill in the art, various other modifications and adaptations of ATM apparatus 210 and parking fee calculating and collection apparatus 220 may be implemented without departing from the broader scope and spirit of the invention. All such variations, rearrangements and enhancements are intended to be encompassed within the invention, as set forth in the claims appended hereto.

What is claimed:

1. An automated parking fee payment station using an ATM network comprising:
ATM apparatus having a keypad, a card reader, a display, a communication interface and a micro-computer controller; and
parking fee calculating and collection apparatus including a ticket reader and parking fee collection apparatus, the ticket reader and parking fee collection apparatus being operatively connected to and utilizing resources of the micro-computer controller to allow payment of the parking fee by transaction of the ATM.

2. The apparatus as recited in claim 1 wherein the card reader is operative to read credit cards and debit cards.

3. The apparatus as recited in claim 1 wherein the ticket reader and micro-controller cooperate to calculate a time based parking fee.

4. The apparatus as recited in claim 3 wherein the communications interface is in electrical communication with an ATM network to debit the calculated parking fee from a users account at a consumer financial institution.

5. The apparatus as recited in claim 3 wherein the communications interface is in electrical communication with a credit card network.

6. The apparatus as recited in claim 1 wherein the parking fee calculation and collection apparatus comprises a parking payment station operatively connected to the micro-computer controller.

7. The apparatus as recited in claim 3 wherein the parking fee collection apparatus and the micro-computer cooperate to collect the time based parking fee.

8. The apparatus as recited in claim 3 wherein the ATM apparatus further comprises a cash dispenser.

9. The apparatus as recited in claim 8 wherein the micro-computer controller and the cash dispenser cooperate to dispense change in response to cash input to the parking fee collection apparatus and the calculated parking fee.

10. The apparatus as recited in claim 9 wherein the cash dispenser is operative to dispense coins and bills.

11. The apparatus as recited in claim 3 wherein the parking fee calculation and collection apparatus includes a cash dispenser.

12. The apparatus as recited in claim 11 wherein the micro-computer controller and cash dispenser cooperate to dispense change in response to cash input to the parking fee collection apparatus and the calculated parking fee.

13. The apparatus as recited in claim 11 wherein the cash dispenser is operative to dispense coin and bills.

14. The apparatus as recited in claim 5 wherein the ATM is operative to charge the calculated parking fee to a users credit card.

15. The apparatus as recited in claim 3 wherein the ATM is operative to debit the calculated parking fee to a users bank account.
